(19) United States
(12) Patent Application Publication
(10) Pub. No.: US 2025/0030062 A1
(43) Pub. Date: Jan. 23, 2025

(54) SECONDARY BATTERY, BATTERY PACK, AND STATIONARY POWER SUPPLY

(71) Applicant: KABUSHIKI KAISHA TOSHIBA, Tokyo (JP)

(72) Inventors: Keigo HOSHINA, Yokohama Kanagawa (JP); Norio TAKAMI, Yokohama Kanagawa (JP)

(73) Assignee: KABUSHIKI KAISHA TOSHIBA, Tokyo (JP)

(21) Appl. No.: 18/583,934

(22) Filed: Feb. 22, 2024

(30) Foreign Application Priority Data
Jul. 21, 2023 (JP) 2023-119247

(51) Int. Cl. H01M 10/42; H01M 4/02; H01M 4/24; H01M 4/505; H01M 4/525; H01M 4/66; H01M 10/26; H01M 50/209; H01M 50/296

(52) U.S. Cl. CPC H01M 10/4235; H01M 4/24; H01M 4/505; H01M 4/525; H01M 4/661; H01M 10/26; H01M 50/209; H01M 50/296; H01M 2004/028; H01M 2220/10

(57) ABSTRACT

In general, according to one embodiment, a secondary battery including an electrolyte, a positive electrode, and a negative electrode is provided. The electrolyte includes water and a lithium salt. The positive electrode includes a positive electrode active material-containing layer, a positive electrode current collector, and a nitrogen-containing substance. The positive electrode current collector supports the positive electrode active material-containing layer. The positive electrode current collector contains at least one of aluminum or an aluminum alloy. The nitrogen-containing substance presents at least a part of a surface of the positive electrode current collector.

### CROSS-REFERENCE TO RELATED APPLICATIONS

This application is based upon and claims the benefit of priority from Japanese Patent Application No. 2023-119247, filed Jul. 21, 2023, the entire contents of which are incorporated herein by reference.

### FIELD

Embodiments described herein relate generally to a secondary battery, a battery pack, a vehicle, and a stationary power supply.

### BACKGROUND

Nonaqueous electrolyte batteries, in particular, lithium secondary batteries, which use a carbon material or a lithium titanium oxide as a negative electrode active material and a layered oxide containing nickel, cobalt, manganese and the like as a positive electrode active material, have been put to practical use as power supplies in a wide range of fields. In these lithium secondary batteries, a nonaqueous solvent such as an organic solvent obtained by mixing ethylene carbonate, methylethyl carbonate and the like is used for an electrolytic solution unlike nickel-metal hydride batteries or lead-acid storage batteries. Electrolytic solutions using these solvents have high oxidation resistance and reduction resistance, and hardly undergo electrolysis of the solvent.

On the other hand, since most of organic solvents are flammable substances, secondary batteries using an organic solvent are likely to be fundamentally inferior in safety to nickel-metal hydride batteries and lead-acid storage batteries.

Lithium secondary batteries including an electrolytic solution including an aqueous solution have higher safety than secondary batteries using an organic solvent, but raise a problem that an Al positive electrode current collector used in a lithium secondary battery or the like is corroded. Corrosion of a positive electrode current collector reduces the charge-discharge efficiency or the cycle life of a secondary battery. It is required to suppress corrosion of a positive electrode current collector in a secondary battery including an electrolytic solution containing water.

### BRIEF DESCRIPTION OF DRAWINGS

FIG. 1 is a cross-sectional view schematically showing an example of a secondary battery according to an embodiment.

FIG. 2 is a schematic cross-sectional view of the secondary battery shown in FIG. 1 taken along line II-II.

FIG. 3 is a partially cut-out perspective view schematically showing another example of the secondary battery according to the embodiment.

FIG. 4 is an enlarged cross-sectional view of section E of the secondary battery shown in FIG. 3.

FIG. 5 is a perspective view schematically showing an example of a battery module according to an embodiment.

FIG. 6 is an exploded perspective view schematically showing an example of a battery pack according to an embodiment.

FIG. 7 is a block diagram showing an example of an electric circuit of the battery pack shown in FIG. 6.

FIG. 8 is a partial perspective view schematically showing an example of a vehicle according to an embodiment.

FIG. 9 is a block diagram showing an example of a system including a stationary power supply according to an embodiment.

FIG. 10 is a schematic view showing a first example of a positive electrode of a secondary battery according to an embodiment.

FIG. 11 is a schematic view showing a second example of a positive electrode of a secondary battery according to an embodiment.

FIG. 12 is a schematic view showing a third example of a positive electrode of a secondary battery according to an embodiment.

### DETAILED DESCRIPTION

In general, according to one embodiment, a secondary battery including an electrolyte, a positive electrode, and a negative electrode is provided. The electrolyte includes water and a lithium salt. The positive electrode includes a positive electrode active material-containing layer, a positive electrode current collector, and a nitrogen-containing substance. The positive electrode current collector supports the positive electrode active material-containing layer. The positive electrode current collector contains at least one of aluminum or an aluminum alloy. The nitrogen-containing substance presents at least a part of a surface of the positive electrode current collector.

According to another embodiment, a battery pack including the secondary battery of the embodiment is provided.

According to another embodiment, a vehicle including the secondary battery of the embodiment is provided.

According to another embodiment, a stationary power supply including the secondary battery of the embodiment is provided.

### First Embodiment

According to an embodiment, a secondary battery including an electrolyte, a positive electrode, and a negative electrode is provided. The electrolyte includes water and a lithium salt. The positive electrode includes a positive electrode active material-containing layer, a positive electrode current collector, and a nitrogen-containing substance. The positive electrode current collector supports the positive electrode active material-containing layer and contains at least one of aluminum or an aluminum alloy. The nitrogen-containing substance presents at at least a part of a surface of the positive electrode current collector.

For suppressing corrosion of a positive electrode current collector in a secondary battery including an electrolyte containing water, forming the positive electrode current collector from a metal which hardly corrodes (for example, Ti), increasing the concentration of electrolytic solution to reduce the content of water, or the like has been proposed. However, not only suppression of corrosion by these methods is not sufficient, but also resistance increases.

The inventors have discovered that in a secondary battery including an electrolyte containing water and a lithium salt, a nitrogen-containing substance is stably present at a surface of a positive electrode current collector containing at least one of aluminum or an aluminum alloy, whereby a reaction between the positive electrode current collector and the electrolyte is suppressed, so that corrosion of the positive electrode current collector is suppressed. Therefore, it is possible to improve the charge-and-discharge cycle performance of the secondary battery including an electrolyte containing water.

Hereinafter, the positive electrode, the negative electrode and the electrolyte of the secondary battery of the embodiment will be described in detail.

### <Positive Electrode>

The positive electrode includes a positive electrode current collector containing at least one of aluminum or an aluminum alloy, and a positive electrode active material-containing layer.

The positive electrode current collector has, for example, a sheet shape. The positive electrode current collector has, for example, a first surface crossing a thickness direction of the positive electrode current collector, and a second surface crossing the thickness direction of the positive electrode current collector and located away from the first surface. The second surface is located on a side opposite to the first surface.

The positive electrode current collector may be substantially formed of at least one of aluminum or an aluminum alloy, or contain another material. Examples of the positive electrode current collector include aluminum foils, and aluminum alloy foils. The purity of the aluminum foil can be set to 99.99% by mass or more. Examples of the aluminum alloy include alloys containing at least one element selected from the group consisting of magnesium, zinc and silicon. The positive electrode current collector may contain a transition metal such as iron, copper, nickel or chromium. The transition metal content of the positive electrode current collector can be set to 100 ppm by mass or less.

In the positive electrode current collector, a nitrogen-containing substance is present at the whole of a surface including the first surface and the second surface or a part of the surface. The nitrogen-containing substance may be, for example, precipitated or deposited on a surface of the positive electrode current collector by an electrochemical reaction or the like. The nitrogen-containing substance may be, for example, a nitrogen-containing film or a nitrogen-containing layer. Examples of the nitrogen-containing substance include nitrogen-containing compounds, nitrogen-containing inorganic substances, and nitrogen-containing organic substances. Examples of the nitrogen-containing inorganic substance include metal nitrides such as Li₃N and AlN. The nitrogen-containing inorganic substance can suppress corrosion of the positive electrode current collector without impairing lithium ion conductivity of the positive electrode. One or more than one kind of nitrogen-containing substance may be present at the surface of the positive electrode current collector.

The thickness of the positive electrode current collector is preferably 5 μm to 50 μm. The current collector having such a thickness can maintain a balance the strength and weight reduction of the electrode.

The positive electrode active material-containing layer contains a positive electrode active material. The positive electrode active material-containing layer can be supported (or formed or stacked) on, for example, at least a part of the first surface, at least a part of the second surface, or at least a part of each of the first surface and the second surface of the positive electrode current collector. A portion of the positive electrode current collector on which the positive electrode active material-containing layer is not supported can function as a positive electrode tab or a positive electrode lead.

The nitrogen-containing substance may be present in the positive electrode active material-containing layer. The nitrogen-containing substance may be present at at least a part of a surface of the positive electrode active material-containing layer. This enables increasing the overvoltage, so that oxidative decomposition of water can be suppressed, and it is possible to improve the charge-discharge efficiency of the secondary battery.

The nitrogen-containing substance may be present between the positive electrode current collector and the positive electrode active material-containing layer. The nitrogen-containing substance may be present at a surface of the positive electrode current collector on which the positive electrode active material-containing layer is not supported. The surface of the positive electrode current collector on which the positive electrode active material-containing layer is not supported may include a portion capable of functioning as a positive electrode tab or a positive electrode lead.

The positive electrode active material-containing layer may further contain a conductive agent, a binder, or both. The conductive agent is added, as necessary, to enhance the current-collecting performance and to suppress a contact resistance between the active material and the current collector. The binder can bind the active material, the conductive agent and the current collector.

A compound having a lithium ion insertion/extraction potential of 3 V (vs.Li/Li⁺) to 5.5 V (vs.Li/Li⁺) as a potential based on metal lithium can be used as the positive electrode active material. The positive electrode may contain one kind of positive electrode active material or two or more kinds of positive electrode active materials.

Examples of the positive electrode active material include lithium manganese composite oxides (for example, LiₓMn₂O₄(0<x≤1) having a spinel structure and LiₓMnO₂ (0<x≤1) having a spinel structure), lithium nickel composite oxides, lithium nickel manganese composite oxides (for example, those of spinel type such as LiₓMn_{2-y}Ni_{y}O₄ (0<x≤1, 0<y<2)), lithium cobalt aluminum composite oxides, lithium nickel cobalt manganese composite oxides (for example, LiₓNi_{1-y-z}Co_{y}Mn_{z}O₂; 0<x≤1, 0<y<1, 0<z<1, y+z<1), lithium manganese cobalt composite oxides (for example, LiₓMn_{y}Co_{1-y}O₂ (0<x≤1, 0<y<1)), lithium iron oxides, lithium fluorinated iron sulfates (for example, LiₓFeSO₄F (0<x≤1)), phosphate compounds having an olivine crystal structure (for example, LiₓFePO₄ (0<x≤1), LiₓMnPO₄ (0<x≤1), and LiₓCoPO₄ (0<x≤1)), lithium cobalt composite oxides (for example, LiₓCoO₂ (0<x≤1)), lithium manganese iron composite oxides (for example, LiₓFe_{1-y}Mn_{y}PO₄ (0<x≤1, 0<y≤1)), lithium nickel aluminum composite oxides (for example, LiₓNi_{1-y}Al_{y}O₂ (0<x≤1, 0<y<1)), lithium manganese aluminum composite oxide (for example, LiₓMn_{2-y}Al_{y}O₄; 0<x≤1, 0<y≤0.5), and lithium nickel cobalt composite oxide (for example, LiₓNi_{1-y-z}Co_{y}Mn_{z}O₂ (0<x≤1, 0<y<1, 0≤z<1)). The phosphate compound having an olivine crystal structure has excellent thermal stability.

At least one selected from the group consisting of a lithium nickel cobalt manganese composite oxide, a lithium nickel manganese composite oxide, a lithium cobalt composite oxide, and a lithium manganese iron composite oxide has a high positive electrode potential and allows for obtainment of a high energy density.

The positive electrode active material is included in the positive electrode in the form of particles, for example. The positive electrode active material particles may be discrete primary particles, secondary particles as an agglomerate of primary particles, or a mixture of primary particles and secondary particles. The shape of the particles is not particularly limited, and may be a spherical shape, an elliptical shape, a flat shape, a fibrous form, or the like.

The average particle size (diameter) of the primary particles of the positive electrode active material is preferably 10 μm or less, and more preferably 0.1 μm to 5 μm. The average particle size (diameter) of the secondary particles of the positive electrode active material is preferably 100 μm or less, and more preferably 10 μm to 50 μm.

The binder can fill gaps among the positive electrode active material and also bind the positive electrode active material with the positive current collector. Examples of the binder include polytetrafluoro ethylene (PTFE), polyvinylidene fluoride (PVdF), fluororubber, a polyacrylic acid compound, an imide compound, carboxymethyl cellulose (CMC), and salts of CMC. One of these may be used as the binder, or alternatively, two or more of these may be used in combination as the binder.

The conductive agent can enhance the current-collecting performance and suppress a contact resistance between the positive electrode active material and the positive electrode current collector. Examples of the conductive agent include carbonaceous materials such as vapor grown carbon fiber (VGCF), carbon black such as acetylene black, and graphite. One of these may be used as the conductive agent, or alternatively, two or more of these may be used in combination as the conductive agent. The conductive agent may be omitted.

In the positive electrode active material-containing layer, the positive electrode active material and the binder are preferably blended at a ratio of 80% by mass to 98% by mass, and 2% by mass to 20% by mass, respectively.

Setting the amount of the binder to 2% by mass or more can yield sufficient electrode strength. The binder can serve as an insulator. Thus, setting the amount of the binder to 20% by mass or less reduces the amount of an insulator included in the electrode and thus can decrease the internal resistance.

If a conductive agent is to be added, the positive electrode active material, the binder, and the conductive agent are preferably blended at a ratio of 77% by mass to 95% by mass, 2% by mass to 20% by mass, and 3% by mass to 15% by mass, respectively.

Setting the amount of the conductive agent to 3% by mass or more can produce the above-described effects. Setting the amount of the conductive agent to 15% by mass or less can decrease the proportion of the conductive agent that contacts the electrolyte. If said proportion is low, decomposition of the electrolyte can be reduced during storage under high temperature.

To produce the positive electrode, for example, the positive electrode active material, the conductive agent, and the binder are suspended in a solvent to prepare a slurry. The slurry is applied to either one or both surfaces (at least one of the first surface or the second surface) of the current collector. The applied slurry is then dried to obtain a stack of the active material-containing layer and the current collector. Thereafter, the stack is pressed. The positive electrode is thus produced. Alternatively, the positive electrode may be produced by the following method. First, the active material, the conductive agent, and the binder are mixed to obtain a mixture. Next, the mixture is formed into pellets. These pellets are then arranged on the current collector, whereby the positive electrode can be obtained.

### <Negative Electrode>

The negative electrode includes a negative electrode current collector and a negative electrode active material-containing layer supported (or formed or stacked) on either one surface (one main surface) or both surfaces (both of front and back surfaces) of the negative electrode current collector. The negative electrode active material-containing layer includes a negative electrode active material.

The negative electrode may contain a nitrogen-containing substance. The nitrogen-containing substance may be present in, for example, at least one of the negative electrode active material-containing layer or the negative electrode current collector. Details of the nitrogen-containing substance are as described for the positive electrode.

The negative electrode current collector may be made of, for example, a material that is electrochemically stable in the electric potential at which lithium (Li) is inserted into and extracted from the active material. Examples of the negative electrode current collector include: a conductive sheet that includes a conductive material and a polymeric material; a conductive sheet that includes at least one kind of metal element selected from the group consisting of Pb, Bi, Zn, Sb, and Sn; a foil made of a metal such as copper, nickel, stainless steel, or aluminum; and an aluminum alloy foil that includes one or more elements selected from Mg, Ti, Zn, Mn, Fe, Cu, and Si. Examples of the polymeric material of the conductive sheet that can be used include polyethylene, polypropylene, polyethylene terephthalate, polyacrylonitrile, polymethylmethacrylate, and polyvinylidene fluoride. A conductive filler such as a carbonaceous material is preferably used as the conductive material. Examples of the carbonaceous material that can be used include carbon black, ketjen black, graphite, fibrous carbon, and carbon nanotubes. One or more than one kind of conductive material and one or more than one kind of polymeric material may be used.

The thickness of the negative electrode current collector is preferably 5 μm to 50 μm. The current collector having such a thickness can maintain a balance the strength and weight reduction of the electrode.

The negative electrode current collector may also include a portion that does not have the active material-containing layer formed on its surface. This portion can serve as a current-collecting tab or a current-collecting lead.

Examples of the negative electrode active material include carbon (carbon-based materials), titanium-containing oxides, Li metal, and Li alloys. One or more than one kind of negative electrode active material may be used. Examples of the carbon (carbon-based material) include graphite and carbon bodies. Examples of the Li alloy include alloys such as Li—Al, Li—Si, Li—Zn and Li—Mg.

The negative electrode active material includes a titanium-containing oxide. The titanium-containing oxide includes, for example, a titanium-containing oxide that can turn into a titanium-containing oxide that includes Li through a lithium-ion (Li⁺) insertion-extraction reaction or a charge-discharge reaction. Thus, the Ti-containing oxide may be a titanium-containing oxide that does not include Li. The titanium-containing oxide that does not include Li includes the case where it includes substantially no Li.

Examples of the titanium-containing oxide include niobium titanium-containing oxides, titanium oxides, and lithium titanium-containing oxides.

Examples of the niobium titanium-containing oxide include niobium titanium-containing oxides having a monoclinic structure. Examples of the niobium titanium-containing oxide having a monoclinic structure include Nb₂TiO₇, Nb₂Ti₂O₉, Nb₁₀Ti₂O₂₉, Nb₁₄TiO₃₇ and Nb₂₄TiO₆₂. The niobium titanium-containing oxides may be substituted niobium titanium composite oxides in which at least a part of Nb and/or Ti has been substituted by an element other than Nb and Ti. Examples of the substituting element include Na, K, Ca, Co, Ni, Si, P, V, Cr, Mo, Ta, Zr, Mn, Fe, Mg, B, Pb, and Al. The substituted niobium titanium composite oxides may include one or more than one kind of substituting element. The active material particles may include one or more than one kind of niobium titanium-containing oxide. The niobium titanium-containing oxides preferably include Nb₂TiO₇ having a monoclinic structure. In this case, an electrode having an excellent capacity and excellent rate performance can be obtained.

An example of the monoclinic niobium titanium-containing oxides is compounds represented by LiₓTi_{1-y}M1_{y}Nb_{2-z}M2_{z}O_{7+δ}. Here, M1 is at least one selected from the group consisting of Zr, Si, and Sn, and M2 is at least one selected from the group consisting of V, Ta, and Bi. The respective subscripts in the composition formula are specified as follows: 0≤x≤5, 0≤y<1, 0≤z<2, and −0.3≤δ≤0.3.

Another example of the monoclinic niobium titanium-containing oxides is compounds represented by Ti_{1-y}M3_{y+z}Nb_{2-z}O_{2-δ}. Here, M3 is at least one selected from Mg, Fe, Ni, Co, W, Ta, and Mo. The respective subscripts in the composition formula are specified as follows: 0≤y<1, 0≤z<2, and −0.3≤δ≤0.3.

Another example of the monoclinic niobium titanium-containing oxides is those represented by LiₐTiM_{b}Nb_{2±β}O_{7±σ} (0≤a≤5, 0≤b≤0.3, 0≤β≤0.3, 0≤σ≤0.3, and M is at least one kind of element selected from the group consisting of Fe, V, Mδ and Ta).

The titanium oxides include, for example, a titanium oxide having a monoclinic structure, a titanium oxide having a rutile structure, and a titanium oxide having an anatase structure. The composition of the titanium oxides having these crystal structures before charging can be represented by TiO₂, and the composition thereof after charging can be represented by LiₓTiO₂ (x is 0≤x≤1). The structure of the titanium oxide having a monoclinic structure before charging can be represented by TiO₂(B).

Examples of the lithium titanium-containing oxide include lithium titanium oxides having a spinel structure (for example, compounds represented by a general formula Li₄₊ₓTi₅O₁₂, where −1≤x≤3); lithium titanium oxides having a ramsdellite structure (for example, compounds represented by Li₂₊ₓTi₃O₇, where −1≤x≤3); compounds represented by Li₁₊ₓTi₂O₄, where 0≤x≤1; compounds represented by Li_{1.1+x}Ti_{1.8}O₄, where 0≤x≤1; compounds represented by Li_{1.07+x}Ti_{1.86}O₄, where 0<x≤1; and compounds represented by LiₓTiO₂, where 0<x≤1. The lithium titanium-containing oxide may be a lithium titanium composite oxide containing an element other than lithium and titanium.

One or more than one kind of negative electrode active material may be used.

When a negative electrode containing at least one selected from the group consisting of a niobium titanium-containing oxide, a titanium oxide and a lithium titanium-containing oxide is combined with a positive electrode containing at least one selected from the group consisting of a lithium nickel cobalt manganese composite oxide, a lithium nickel manganese composite oxide, a lithium cobalt composite oxide and a lithium manganese iron composite oxide, it is possible to obtain a secondary battery having a high voltage and energy density.

The negative electrode active material is included in the negative electrode active material-containing layer in the form of particles, for example. The negative electrode active material particles may be primary particles, secondary particles as an agglomerate of primary particles, or a mixture of discrete primary particles and secondary particles. The shape of the particles is not particularly limited, and may be a spherical shape, an elliptical shape, a flat shape, a fibrous form, and the like.

The average particle size (diameter) of the primary particles of the negative electrode active material is preferably 3 μm or less, and more preferably 0.01 μm to 1 μm. The average particle size (diameter) of the secondary particles of the negative electrode active material is preferably 30 μm or less, and more preferably 5 μm to 20 μm.

The negative electrode active material-containing layer may contain a binder. The binder can fill gaps among the active material and also bind the active material with the negative electrode current collector. Examples of the binder include polytetrafluoro ethylene (PTFE), polyvinylidene fluoride (PVdF), fluororubber, styrene butadiene rubber (SBR), a polyacrylic acid compound, an imide compound, carboxymethyl cellulose (CMC), and salts of CMC. One of these may be used as the binder, or alternatively, two or more of these may be used in combination as the binder.

The negative electrode active material-containing layer may include a conductive agent. The conductive agent is added, as necessary, to enhance the current-collecting performance and to suppress a contact resistance between the active material and the current collector.

Examples of the conductive agent include carbonaceous materials such as acetylene black, ketjen black, graphite, or coke. A single kind of conductive agent, or a mixture of two or more kinds of conductive agents may be used.

The blending ratios of the negative electrode active material, the conductive agent and the binder are preferably in the range of 70% by mass to 95% by mass, 3% by mass to 20% by mass and 0.6% by mass to 10% by mass, respectively. When the blending ratio of the conductive agent is 3% by mass or more, the current-collecting performance of the negative electrode active material-containing layer can be improved. When the blending ratio of the binder is 2% by mass or more, sufficient electrode strength is obtained. The binder can serve as an insulator. Thus, when the blending ratio of the binder is 10% by mass or less, the insulation area inside the electrode can be reduced.

The negative electrode can be produced, for example, by the following method. First, the negative electrode active material, the conductive agent and the binder are suspended in a water solvent to prepare a slurry. The slurry is applied to either one or both surfaces of the current collector. The applied slurry is then dried to obtain a stack of the active material-containing layer and the current collector. Thereafter, the stack is pressed. The negative electrode is thus produced.

### <Electrolyte>

The electrolyte includes water and a lithium salt.

The electrolyte includes an aqueous solvent and a lithium salt dissolved in an aqueous solvent. The electrolyte may be liquid or gelatinous. A liquid electrolyte is, for example, an aqueous solution prepared by dissolving a lithium salt as a solute in an aqueous solvent. A gelatinous electrolyte is, for example, prepared by mixing a liquid electrolyte and a polymeric compound to form a composite thereof. Examples of the polymeric compound include polyvinylidene fluoride (PVdF), polyacrylonitrile (PAN), and polyethylene oxide (PEO). When the electrolyte is held in both the negative electrode active material-containing layer and the positive electrode active material-containing layer, the type of the electrolyte held in the negative electrode active material-containing layer may be the same or different from the type of the electrolyte held in the positive electrode active material-containing layer.

A solution containing water can be used as the aqueous solvent. The solution containing water may be pure water or a mixed solvent of water and an organic solvent. Examples of the solvent (organic solvent) include phosphoric acid esters such as trimethyl phosphate (TMP), cyclic carbonates such as ethylene carbonate (EC), and chain carbonates.

The content of water in the electrolyte can be set to 150 ppm by mass to 100,000 ppm by mass. Setting the content of water to 150 ppm by mass or more can enhance the safety of the electrolyte. Setting the content of water to 100,000 ppm by mass or less can suppress gas generation by electrolysis of water. The content of water can be set to 200 ppm by mass or more. This enhances the solubility of a N-containing compound (for example, a nitric acid-based compound) in the electrolyte, so that production of the nitrogen-containing substance in the positive electrode can be promoted. The safety of the electrolyte can be further enhanced.

For example, a lithium salt can be used as an electrolyte salt. One or more than one kind of lithium salt may be used.

For example, lithium chloride (LiCl), lithium bromide (LiBr), lithium hydroxide (LiOH), lithium sulfate (Li₂SO₄), lithium acetate (CH₃COOLi), lithium oxalate (Li₂C₂O₄), lithium carbonate (Li₂CO₃), lithium difluoro (oxalato)borate (LiDFOB, C₂BF₂LiO₄), lithium bis(trifluoro methanesulfonyl)imide (LiTFSI; LiN(CF₃SO₂)₂), lithium bis(fluorosulfonyl)imide (LiFSI; LiN(FSO₂)₂), lithium bis(pentafluoro ethanesulfonyl)imide (LiBETI; LiN(SO₂C₂F₅)₂), lithium bisoxalateborate (LiBOB:LiB[(OCO)₂]₂), or lithium triflate (LiOtF; LiCF₃SO₃, also known as lithium trifluoromethylsulfonate) can be used as the lithium salt.

The lithium salt may include a lithium salt having an imide bond. Preferred examples of the lithium salt having an imide bond include LiTFSI (LiN(CF₃SO₂)₂), and LiBETI (LiN(SO₂C₂F₅)₂). LiTFSI has high stability against water, and thus is hardly hydrolyzed, so that gas generation can be suppressed. On the other hand, the nitrogen-containing substance can suppress a reaction between the electrolyte containing LiTFSI and the positive electrode current collector. Thus, when an electrolyte containing LiTFSI is combined with a nitrogen-containing substance, it is possible to provide a secondary battery in which hydrolysis of a lithium salt is suppressed to suppress gas generation, and corrosion of a positive electrode current collector is suppressed.

The concentration of the lithium salt in the electrolyte can be in a range of 1.2 mol/kg to 3.8 mol/kg. When the concentration of the lithium salt is in the above range, the ion conductivity of the electrolyte can be enhanced. A more preferred range of the concentration of the lithium salt is 1.8 mol/kg to 3.5 mol/kg. The concentration was calculated as a numerical value in the unit of mol/kg by dividing the number of moles of the lithium salt by the weight of the solvent.

It is desirable that the electrolyte include a nitric acid-based compound including at least one selected from the group consisting of lithium nitrate (LiNO₃), sodium nitrate (NaNO₃), potassium nitrate (KNO₃), magnesium nitrate (Mg(NO₃)₂), calcium nitrate (Ca(NO₃)₂), lithium nitrite (LiNO₂), sodium nitrite (NaNO₂), potassium nitrite (KNO₂), magnesium nitrite (Mg(NO₂)₂) and calcium nitrite (Ca(NO₂)₂). The nitric acid-based compound can form a nitrogen-containing substance on a surface of a positive electrode current collector under certain conditions (an example of which will be described later). As a result, corrosion of the positive electrode current collector can be suppressed, so that it is possible to improve the charge-and-discharge cycle of the secondary battery.

The electrolyte is able to include an N-containing compound, but may or may not include an N-containing compound. As an example, the N-containing compound may be a raw material for the nitrogen-containing substance present in the positive electrode. Examples of the N-containing compound include a nitric acid-based compounds, and organic compounds having a nitrile group. One or more than one kind of N-containing compound may be used. The content of the N-containing compound in the electrolyte can be set to 0.3% by mass to 4% by mass. Setting the content of the N-containing compound to 0.3% by mass or more can enhance the effect of suppressing corrosion of the positive electrode current collector. Setting the content of the N-containing compound to 4% by mass or less can optimize the amount of the nitrogen-containing substance produced, so that an increase in resistance can be suppressed. A more preferred range of the content of the N-containing compound is 0.3 mass % to 1 mass %.

The electrolyte can contain, as an anion species, at least one selected from a chlorine ion (Cl⁻), a hydroxide ion (OH⁻), a sulfate ion (SO₄²⁻) and a nitrate ion (NO₃⁻).

The electrolyte may include a surfactant. Examples of the surfactant include non-ionic surfactants such as polyoxyalkylene alkyl ether, polyethylene glycol, polyvinyl alcohol, thiourea, 3,3′-dithiobis(1-propanesulfonate)disodium, dimercaptothiadiazole, boric acid, oxalic acid, malonic acid, saccharin, sodium naphthalenesulfonate, gelatin, potassium nitrate, aromatic aldehyde, or heterocyclic aldehyde. The surfactant may be used in a single form or in the form of a mixture of two or more kinds thereof.

The battery of the embodiment may further include at least one of a separator or a container member. The positive electrode, the negative electrode and the separator may for an electrode group. The electrolyte may be held in the electrode group.

### <Separator>

The separator is disposed, for example, between the positive electrode and the negative electrode. The separator may include one that covers only one of the positive electrode or the negative electrode.

The separator may have a porous structure. Examples of the porous separator include a non-woven fabric, a film, and paper. Examples of the component of the porous separator that forms a non-woven fabric, a film, paper, and the like include polyolefins, such as polyethylene or polypropylene, and cellulose. Preferred examples of the porous separator include non-woven fabrics including cellulose fibers and porous films including polyolefin fibers.

The porous separator preferably has a porosity of 60% or more. The porous separator also preferably has a fiber diameter of 10 μm or less. With a fiber diameter of 10 μm or less, the compatibility of the porous separator to the electrolyte is improved, allowing for a decrease in the battery resistance. A more preferred range of fiber diameter is 3 μm or less. A cellulose fiber-containing non-woven fabric having a porosity of 60% or more exhibits favorable impregnation performance for an electrolyte, and can exhibit high output performance ranging from a low temperature to a high temperature. A more preferred range of porosity is 62% to 80%.

The porous separator preferably has a thickness of 20 μm to 100 μm, and preferably has a density of 0.2 g/cm³ to 0.9 g/cm³. In these ranges, it is possible to maintain a balance between a mechanical strength and reduction of a battery resistance, and to provide a high-output secondary battery with an internal short-circuit suppressed. Also, heat shrinkage of the separator is less likely to occur in a high-temperature environment, allowing for attainment of favorable high-temperature storage performance.

A composite separator that includes a porous separator and a layer formed on one side or both sides of the porous separator and containing inorganic particles may be used as the separator. Examples of the inorganic particles include aluminum oxide and silicon oxide.

A solid electrolyte layer may be used as the separator. The solid electrolyte layer may include solid electrolyte particles and a polymeric component. The solid electrolyte layer may be made only of solid electrolyte particles. The solid electrolyte layer may include one kind of solid electrolyte particles or more than one kind of solid electrolyte particles. The solid electrolyte layer may include at least one selected from the group consisting of a plasticizer and an electrolyte salt. For example, if the solid electrolyte layer includes an electrolyte salt, the alkali metal ion conductivity of the solid electrolyte layer can be further enhanced. The polymeric material may be in a granular form or a fibrous form.

The solid electrolyte layer is preferably sheet-shaped with few or no pinhole-like pores. The thickness of the solid electrolyte layer is not particularly limited, but is, for example, 150 μm or less, and preferably 20 μm to 50 μm.

The polymeric component used in the solid electrolyte layer is preferably a polymeric component insoluble in an aqueous solvent. Examples of a polymeric component satisfying this condition include polyethylene terephthalate (PET), polypropylene (PP), polyethylene (PE), and a fluorine-containing polymeric component. By using a fluorine-containing polymeric component, the separator can have water-repellent properties. Also, an inorganic solid electrolyte has high stability against water and has excellent lithium ion conductivity. Combining an inorganic solid electrolyte having lithium ion conductivity and a fluorine-containing polymeric component to form a composite can realize a solid electrolyte layer with alkali metal ion conductivity and flexibility. The separator made of said solid electrolyte layer can reduce resistance, and thus can improve the large-current performance of the secondary battery.

Examples of the fluorine-containing polymeric component include polytetrafluoro-ethylene (PTFE), polychlorotrifluoroethylene (PCTFE), ethylene-tetrafluoroethylene copolymer, and polyvinylidene fluoride (PVdF). One or more than one kind of fluorine-containing polymeric component may be used.

If the solid electrolyte layer contains a polymeric component, a proportion of the polymeric component contained in the solid electrolyte layer is preferably 1% by mass to 20% by mass. In this range, a high mechanical strength can be achieved when the solid electrolyte layer has a thickness of 10 μm to 100 μm, and the resistance can be reduced. Furthermore, there is a low possibility that the solid electrolyte will be a factor of inhibiting lithium ion conductivity. A more preferred range of the proportion is 3% by mass to 10% by mass.

An inorganic solid electrolyte is preferably used as the solid electrolyte. The inorganic solid electrolyte is a solid substance having Li-ion conductivity. Herein, having Li-ion conductivity means showing a lithium ion conductivity of 1×10⁻⁶ S/cm or more at 25° C. An inorganic solid electrolyte is, for example, an oxide-based solid electrolyte or a sulfide-based solid electrolyte. Specific examples of the inorganic solid electrolyte are described below.

A lithium phosphate solid electrolyte having a NASICON (sodium (Na) super ionic conductor)-type structure and represented by a general formula Li₁₊ₓMα₂(PO₄)₃ is preferably used as the oxide-based solid electrolyte. Ma in the above general formula is, for example, at least one selected from the group consisting of titanium (Ti), germanium (Ge), strontium (Sr), zirconium (Zr), tin (Sn), aluminum (Al), and calcium (Ca). The subscript x in the above general formula is in a range of 0≤x≤2.

Specific examples of the lithium phosphate solid electrolyte having a NASICON-type structure include: LATP compounds represented by Li₁₊ₓAlₓTi₂₋ₓ(PO₄)₃, where 0.1×0.5; compounds represented by Li₁₊ₓAl_{y}MB_{2-y}(PO₄)₃, where MB is at least one selected from the group consisting of Ti, Ge, Sr, Zr, Sn, and Ca, and 0≤x≤1 and 0≤y≤1; compounds represented by Li₁₊ₓAlₓGe₂₋ₓ(PO₄)₃, where 0≤x≤2; compounds represented by Li₁₊ₓAlₓZr₂₋ₓ(PO₄)₃, where 0≤x≤2; compounds represented by Li_{1+x+y}AlₓMγ₂₋ₓSi_{y}P_{3-y}O₁₂, where Mγ is at least one selected from the group consisting of Ti and Ge, and 0<x≤2, 0≤y<3; and compounds represented by Li₁₊₂ₓZr₁₋ₓCaₓ (PO₄)₃, where 0≤x<1.

Examples of the oxide-based solid electrolyte also include the following in addition to the above lithium phosphate solid electrolytes: amorphous LIPON compounds represented by LiₓPO_{y}N_{z}, where 2.6≤x≤3.5, 1.9≤y≤3.8, and 0.1≤z≤1.3 (e.g., Li_{2.9}PO_{3.3}N_{0.46}); compounds having a garnet structure and represented by La₅₊ₓAₓLa₃₋ₓMδ₂O₁₂, where A is at least one selected from the group consisting of Ca, Sr, and Ba, Mδ is at least one selected from the group consisting of Nb and Ta, and 0≤x≤0.5; compounds represented by Li₃Mδ₂₋ₓL₂O₁₂, where Mδ is at least one selected from the group consisting of Nb and Ta, L may include Zr, and 0≤x≤0.5; compounds represented by Li₇₋₃ₓAlₓLa₃Zr₃O₁₂, where 0≤x≤0.5; LLZ compounds represented by Li₅₊ₓLa₃Mδ₂₋ₓZrₓO₁₂, where Mδ is at least one selected from the group consisting of Nb and Ta, and 0≤x≤2 (e.g, Li₇La₃Zr₂O₁₂); and compounds having a perovskite structure and represented by La_{2/3-x}LiₓTiO₃, where 0.3≤x≤0.7.

One or more of the above compounds may be used as the solid electrolyte. Two or more of the above solid electrolytes may be used.

### <Container Member>

The container member houses at least the positive electrode, the negative electrode, the separator, and the electrolyte. As the container member, a metallic container, a container made of a laminated film, or a container made of resin, for example, may be used. As the metallic container, a metal can made of nickel, iron, stainless steel and the like and having a prismatic and cylindrical shape may be used. As the container made of resin, a container made of polyethylene, polypropylene or the like may be used.

The thickness of the laminated film is, for example, 0.5 mm or less, and preferably 0.2 mm or less.

As the laminated film, a multilayer film including multiple resin layers and a metal layer interposed between the resin layers is used. The resin layer includes, for example, a polymeric material such as polypropylene (PP), polyethylene (PE), nylon, or polyethylene terephthalate (PET). The metal layer is preferably made of an aluminum foil or an aluminum alloy foil for reduction in weight. The laminated film may be formed into the shape of the container member by heat-sealing.

The wall thickness of the metallic container is, for example, 1 mm or less, more preferably 0.5 mm or less, and still more preferably 0.2 mm or less.

The metallic container is made, for example, of aluminum, an aluminum alloy or the like. The aluminum alloy preferably contains an element(s) such as magnesium, zinc, silicon, and the like. If the aluminum alloy contains a transition metal such as iron, copper, nickel, or chromium, the content thereof is preferably 100 ppm by mass or less.

The shape of the container member is not particularly limited. The shape of the container member may be, for example, flat (thin), prismatic, cylindrical, coin-shaped, button-shaped, or the like. The container member can be suitably selected depending on the size of the battery or the use of the battery.

The secondary battery according to the embodiment may be used in various shapes such as a prismatic shape, a cylindrical shape, a flat shape, a thin shape, or a coin shape. The secondary battery may be a secondary battery having a bipolar structure. For example, the secondary battery may be one that has a bipolar structure in which the electrode group has a positive electrode active material-containing layer on one side of a single current collector and a negative electrode active material-containing layer on the other side of the current collector. In this case, there is an advantage in that a plurality of cells in series can be formed of a single cell.

Hereinafter, methods of measuring the positive electrode active material, the negative electrode active material, the nitrogen-containing substance, and the electrolyte will be described below.

If the positive electrode and the negative electrode are included in the battery, the battery is disassembled to remove the positive electrode or the negative electrode, which is then washed using dimethyl carbonate (DMC). The washing method will be described below. The electrode (positive electrode or negative electrode) is immersed in DMC for 5 minutes, and then removed therefrom. This is repeated three times, and then the electrode is dried, followed by the measurement. When repeating the immersion, new DMC is used every time the immersion is carried out.

In the case of removing the electrolyte from the battery, the battery is disassembled, and if the electrolyte is included outside the electrode, the electrolyte not immersed in the electrode is extracted. If the electrolyte cannot be extracted from outside the electrode, the electrode group is put in a centrifugal separator to extract the electrolyte through centrifugation.

### <Positive Electrode Active Material>

The crystal structure and the elemental composition of the positive electrode active material can be measured by powder X-ray diffraction (XRD) measurement and inductively coupled plasma (ICP) emission spectroscopy.

### <Negative Electrode Active Material>

The crystal structure and the elemental composition of the negative electrode active material can be measured by powder X-ray diffraction (XRD) measurement and inductively coupled plasma (ICP) emission spectroscopy.

### <XPS Analysis>

The presence or absence of the nitrogen-containing substance at the surfaces of the positive electrode and the positive electrode current collector can be ascertained by XPS analysis under the conditions described below.

Quantera SXM manufactured by ULVAC-PHI, Inc. or an apparatus having equivalent functions can be used as an XPS apparatus. A single-crystal spectroscopic Al K-α ray (1486.6 eV) is used as an excitation X-ray source. X-ray output is 4 kW (13 kV×310 mA), a photoelectron detection angle is 45°, and an analysis region is about 4 mm×0.2 mm. Scanning is performed at 0.10 eV/step.

### <Electrolyte>

The inclusion of the N-containing compound (e.g., nitric acid-based compound), the lithium salt or water in the electrolyte can be measured by gas chromatography-mass spectrometry (GC-MS) measurement. Also, the water content in the electrolyte can be measured by, for example, evaporating the water in the electrolyte and using a weight ratio between the electrolyte and the residue. A defined amount of the electrolyte is obtained and evaporated in an inert atmosphere. The water content can be calculated based on the weight ratio between the electrolyte and the residue. Also, the water content in the electrolyte can be measured by Karl Fischer measurement (coulometric titration method).

The content of the N-containing compound (e.g., nitric acid-based compound) and the concentration of the lithium salt in the electrolyte can be measured by, for example, inductively coupled plasma (ICP) emission spectroscopy. The molar concentration (mol/kg) can be calculated by weighing a defined amount of the electrolyte and calculating the concentration of the salt contained. The number of moles of the solute and the solvent can be calculated by measuring the specific gravity of the electrolyte.

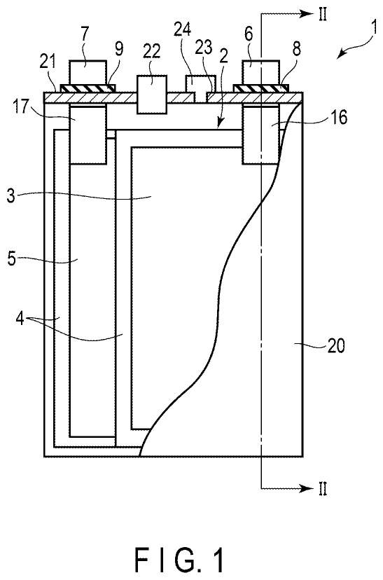

An example in which the battery of the embodiment is applied to a secondary battery will be described with reference to FIGS. 1 to 4.

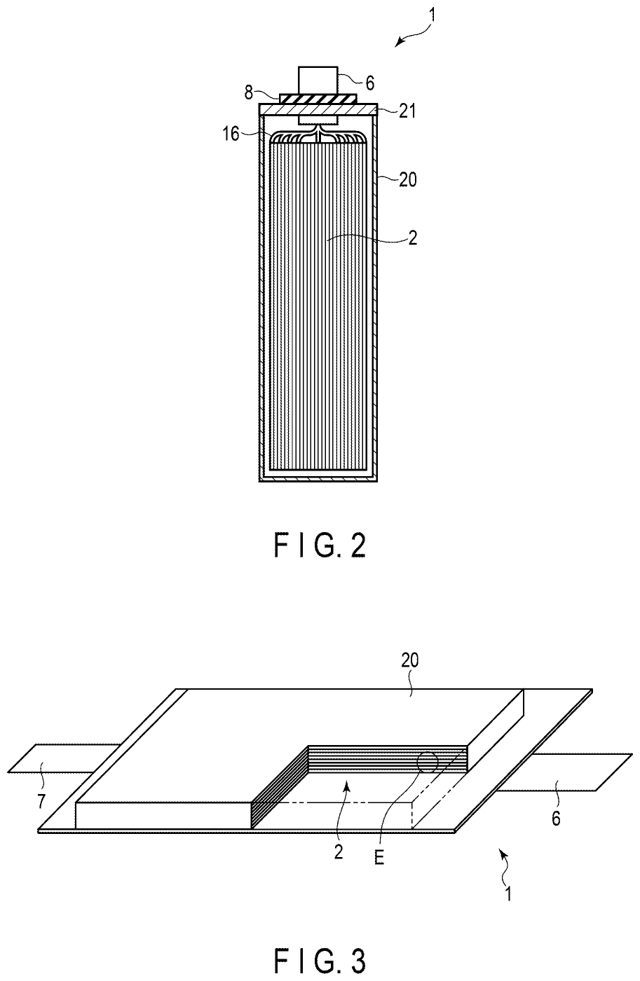

A secondary battery 1 includes an electrode group 2 and a container member 20 which houses the electrode group 2. The electrode group 2 is housed in the container member 20 made of a metallic container having a rectangular tubular shape. The electrode group 2 includes a negative electrode 3, a separator 4, and a positive electrode 5. The electrode group 2 has a structure in which the positive electrode 5 and the negative electrode 3 are spirally wound into a flat shape with the separator 4 interposed therebetween. An electrolyte (not shown) is held by the electrode group 2. As shown in FIG. 2, a strip-shaped negative electrode lead 16 is electrically connected to each of the multiple portions of the end of the negative electrode 3 positioned on the end face of the electrode group 2. A strip-shaped positive electrode lead 17 is also electrically connected to each of the multiple portions of the end of the positive electrode 5 positioned on this end face. A bundle of the negative electrode leads 16 is electrically connected to a negative electrode terminal 6, as shown in FIG. 2. Although not shown, a bundle of the positive electrode leads 17 is also electrically connected to a positive electrode terminal 7.

A sealing plate 21 made of a metal is fixed to an opening of the metallic container member 20 by welding or the like. Each of the negative electrode terminal 6 and the positive electrode terminal 7 is drawn to the outside from an ejection hole provided to the sealing plate 21. A negative electrode gasket 8 and a positive electrode gasket 9 are arranged on the inner peripheral surface of each ejection hole of the sealing plate 21 in order to avoid a short circuit caused by a contact between the negative electrode terminal 6 and the positive electrode terminal 7. Arranging the negative electrode gasket 8 and the positive electrode gasket 9 can maintain the airtightness of a secondary battery 100.

A control valve 22 (safety valve) is arranged on the sealing plate 21. If an inner pressure of a battery is increased due to the gas generated in the container member 20, the generated gas can be diffused from the control valve 22 to the outside. For example, a recoverable valve that operates when the inner pressure becomes higher than a set value and functions as a sealing plug when the inner pressure decreases can be used as the control valve 22. Alternatively, it is possible to use a non-recoverable control valve whose function as a sealing plug does not recover once the control valve operates. Although the control valve 22 is arranged in the center of the sealing plate 21 in FIG. 1, it may be positioned at an end of the sealing plate 21. The control valve 22 may be omitted.

The sealing plate 21 is provided with an injection port 23. An electrolyte may be injected through the injection port 23. The injection port 23 may be closed by a sealing plug 24 after the electrolyte is injected. The injection port 23 and the sealing plug 24 may be omitted.

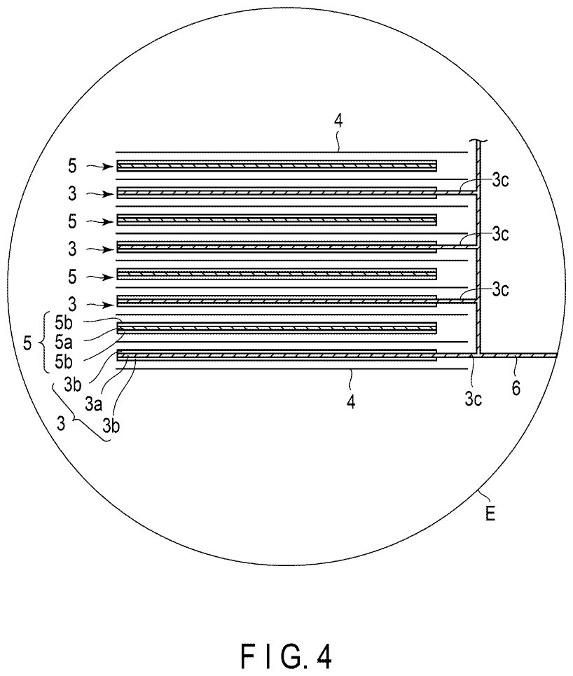

Another example of the secondary battery will be described with reference to FIGS. 3 and 4. FIGS. 3 and 4 respectively show an example of the secondary battery 1 that uses a container member made of a laminated film as a container.

The secondary battery 1 shown in FIGS. 3 and 4 includes the electrode group 2 shown in FIGS. 3 and 4, the container member 20 shown in FIG. 3, and the electrolyte (not shown). The electrode group 2 and the electrolyte are housed in the container member 20. The electrolyte is held by the electrode group 2.

The container member 20 is made of a laminated film including two resin layers and a metal layer interposed therebetween.

As shown in FIG. 4, the electrode group 2 is a stacked electrode group. The stacked electrode group 2 has a structure in which the negative electrode 3 and the positive electrode 5 are alternately stacked with the separator 4 interposed therebetween.

The electrode group 2 includes a plurality of negative electrodes 3. Each of the negative electrodes 3 includes a negative electrode current collector 3a, and a negative electrode active material-containing layer 3b supported on both surfaces of the negative electrode current collector 3a. Also, the electrode group 2 includes a plurality of positive electrodes 5. Each of the positive electrodes 5 includes a positive electrode current collector 5a, and a positive electrode active material-containing layer 5b supported on both surfaces, for example, the first surface and the second surface, of the positive electrode current collector 5a.

The negative electrode current collector 3a of each negative electrode 3 includes, at one side thereof, a portion 3c that does not have the negative electrode active material-containing layer 3b supported on any of its surfaces. This portion 3c serves as a negative electrode current-collecting tab. The portion 3c that serves as a negative electrode current-collecting tab does not overlap with the positive electrode 5, as shown in FIG. 4. The plurality of negative electrode current-collecting tabs (the portion 3c) are electrically connected to the strip-shaped negative electrode terminal 6. The tip of the strip-shaped negative electrode terminal 6 is drawn out of the container member 20.

Although not shown in the figure, the positive electrode current collector 5a of each positive electrode 5 includes, at one side thereof, a portion that does not have the positive electrode active material-containing layer 5b supported on any of its surfaces. This portion serves as a positive electrode current-collecting tab. The positive electrode current-collecting tab does not overlap with the negative electrode 3, as in the case of the negative electrode current-collecting tab (the portion 3c). Also, the positive electrode current-collecting tab is positioned on the opposite side of the electrode group 2 relative to the negative electrode current-collecting tab (the portion 3c). A strip-shaped positive electrode terminal 7 is electrically connected to the positive electrode current-collecting tab. The tip of the strip-shaped positive electrode terminal 7 is positioned on the opposite side relative to the negative electrode terminal 6, and drawn out of the container member 20.

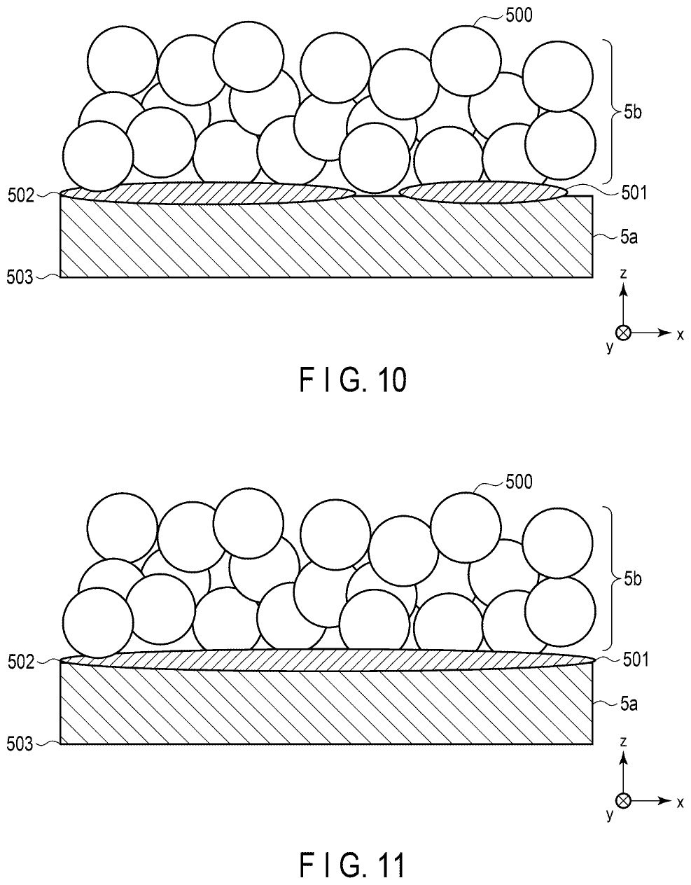

FIGS. 10 to 12 show examples of the positive electrode 5 of the secondary battery. In FIGS. 10 to 12, common members are denoted by the same symbol, and will not be described duplicately. The positive electrode 5 shown in each of FIGS. 10 to 12 includes a positive electrode current collector 5a, a positive electrode active material-containing layer 5b, and a positive electrode tab. In each figure, the positive electrode tab, and the positive electrode active material-containing layer 5b provided on a surface of the positive electrode current collector 5a on which the positive electrode tab is not present are omitted. The positive electrode active material-containing layer 5b contains positive electrode active material particles 500, and components other than the positive electrode active material particles 500 are omitted in each drawing. In each of FIGS. 10 to 12, a direction parallel to the thickness direction of the positive electrode 5 is indicated by a z-axis direction. A first surface 502 and a second surface 503 of the positive electrode current collector 5a are parallel to a surface defined by an x-axis direction and a y-axis direction.

In the positive electrode shown in FIG. 10, a nitrogen-containing substance 501 is present between a part of the first surface 502 of the positive electrode current collector 5a and the positive electrode active material-containing layer 5b. In an example, the nitrogen-containing substance 501 has a layered shape or a film shape.

In the positive electrode shown in FIG. 11, the nitrogen-containing substance 501 is present between the positive electrode active material-containing layer 5b and a portion of the first surface 502 of the positive electrode current collector 5a which faces the positive electrode active material-containing layer 5b. In an example, the nitrogen-containing substance 501 has a layered shape or a film shape.

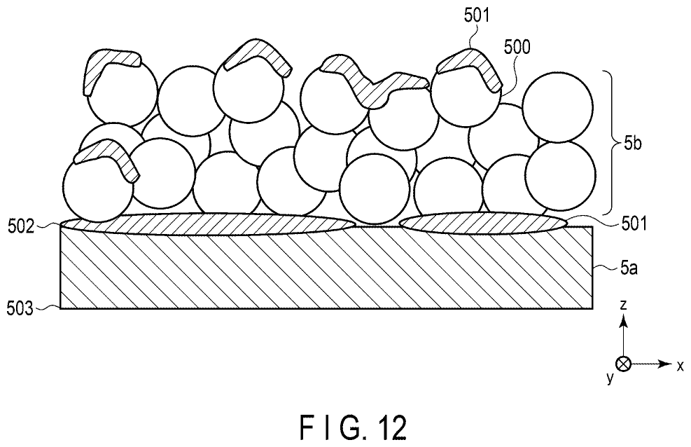

In FIGS. 10 and 11, an example in which the nitrogen-containing substance 501 is present on or in contact with a surface of the positive electrode current collector 5a is shown, but the embodiment is not limited thereto, and for example, as shown in FIG. 12, the nitrogen-containing substance 501 may also be present on or in contact with a part of a surface of the positive electrode active material-containing layer 5b. In the example of FIG. 12, the nitrogen-containing substance 501 is present on or in contact with a part of a surface of the positive electrode current collector 5a, but for example, as shown in FIG. 11, the nitrogen-containing substance 501 may be present on or in contact with the entire portion of the first surface 502 of the positive electrode current collector 5a which faces the positive electrode active material-containing layer 5b. Note that in an example, the nitrogen-containing substance 501 has a layered shape or a film shape.

### <Production Method>

The secondary battery according to the embodiment can be produced, for example, as follows.

A method for producing the secondary battery includes: providing a negative electrode; providing a positive electrode; preparing an electrolyte containing water, a lithium salt and a nitric acid-based compound; providing a container member; housing the negative electrode and the positive electrode in the container member; injecting the electrolyte into the container member; sealing the container member to obtain a battery precursor; aging the battery precursor at 45° C. to 80° C. for 5 minutes to 120 minutes; and performing charge up to a state of charge (SOC) of 30% to 100% at a current rate of 0.05 C to 2 C at room temperature (e.g., 25° C.). The aging at 45° C. to 80° C. for 5 minutes to 120 minutes can lead to a state in which the electrolyte (e.g. an electrolytic solution) sufficiently spreads over the positive electrode containing a positive electrode current collector and a positive electrode layer. Thereafter, a current is applied to the battery to bring the battery into a charged state, whereby a film containing nitrogen can be formed. By this method, a nitric acid-based compound can be decomposed on the positive electrode current collector, so that a nitrogen-containing film as a nitrogen-containing substance can be formed on at least a part of a surface of the positive electrode current collector. After charge-discharge, generated gas can be appropriately removed from the battery.

The negative electrode and the positive electrode can be produced, for example, by the following method. First, the active material, the conductive agent and the binder are suspended in a solvent to prepare a slurry. The slurry is applied to either one or both of front and back surfaces of the current collector. The applied slurry is then dried to obtain a stack of the active material-containing layer and the current collector. Thereafter, the stack is pressed. Each of the electrodes is thus produced. A negative electrode active material is used as an active material in production of the negative electrode, and a positive electrode active material is used as an active material in production of the positive electrode.

Alternatively, each electrode may be produced by the following method. First, the active material, the conductive agent, and the binder are mixed to obtain a mixture. Next, the mixture is formed into pellets. These pellets are then arranged on the current collector, whereby the electrode can be obtained.

The electrolyte can be prepared, for example, by dissolving a lithium salt and a nitric acid-based compound in an aqueous solvent to prepare a solution.

In the production method, the N-containing compound to be contained in the electrolyte is not limited to a nitric acid-based compound. As the N-containing compound, for example, an organic compound having a nitrile group (e.g., adiponitrile) may be used. Even in this case, a nitrogen-containing film as a nitrogen-containing substance can be formed on at least a part of a surface of the positive electrode current collector.

Alternatively, instead of adding a N-containing compound (e.g., a nitric acid-based compound or an organic compound having a nitrile group) as a nitrogen source to the electrolyte, an aluminum foil or an aluminum alloy foil that is a positive electrode current collector is subjected to plasma nitriding treatment, whereby a nitrogen-containing film as a nitrogen-containing substance can be formed on at least a part of a surface of the positive electrode current collector. Thereafter, the active material-containing slurry is applied to one surface or both of front and back surfaces of the positive electrode current collector, and the applied slurry is dried to obtain a stack of the active material-containing layer and the current collector, and the stack is then pressed. The positive electrode may be produced by this method. When a secondary battery is produced using the obtained positive electrode, aging and charge may not be performed under the above conditions, or aging or charge may be omitted.

The secondary battery of the embodiment described above includes a positive electrode, a negative electrode, and an electrolyte containing water and a lithium salt. The positive electrode includes a positive electrode active material-containing layer, a positive electrode current collector supporting the positive electrode active material-containing layer and containing at least one of aluminum or an aluminum alloy, and a nitrogen-containing substance present at at least a part of a surface of the positive electrode current collector. In the secondary battery of the embodiment, corrosion of the positive electrode current collector can be suppressed, so that the charge-and-discharge cycle performance can be improved.

### Second Embodiment

According to a second embodiment, a battery module is provided. The battery module includes a plurality of secondary batteries according to the embodiment.

In the battery module according to the embodiment, individual single batteries may be arranged to be electrically connected in series or in parallel, or may be arranged in a combination of in-series connection and in-parallel connection.

Next, an example of the battery module will be described with reference to the drawings.

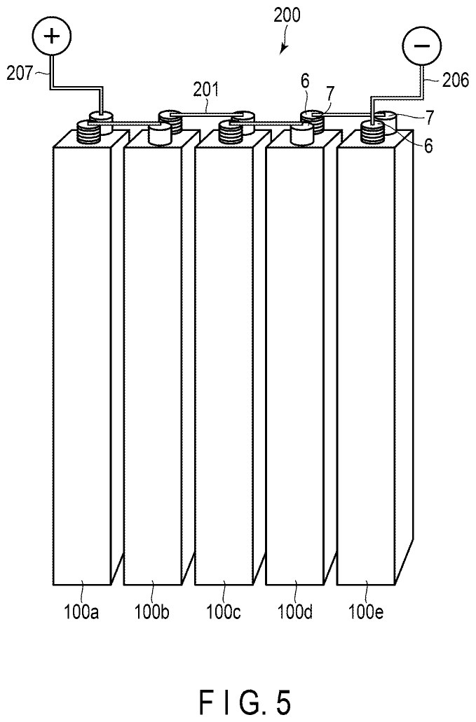

A battery module 200 shown in FIG. 5 includes five single batteries 100a to 100e, four bus bars 201, a positive electrode-side lead 207, and a negative electrode-side lead 206. Each of the five single batteries 100a to 100e is the secondary battery according to the embodiment.

The bus bar 201 connects, for example, a negative electrode terminal 6 of one single battery 100a and a positive electrode terminal 7 of a single battery 100b positioned adjacent to the single battery 100a. In this way, the five single batteries 100 are connected in series by the four bus bars 201. That is, the battery module 200 shown in FIG. 5 is a battery module of five in-series connections. Although not shown, in the battery module that includes single batteries that are electrically connected in parallel, for example, the negative electrode terminals are connected by the bus bars and the positive electrode terminals are connected by the bus bars, whereby the plurality of single batteries may be electrically connected.

The positive electrode terminal 7 of at least one of the five single batteries 100a to 100e is electrically connected to the positive electrode-side lead 207 for external connection. Also, the negative electrode terminal 6 of at least one of the five single batteries 100a to 100e is electrically connected to the negative electrode-side lead 206 for external connection.

The battery module according to the embodiment includes the secondary battery according to the embodiment. Therefore, the battery module can have excellent life performance.

### Third Embodiment

According to a third embodiment, a battery pack which includes the battery according to the embodiment is provided. The battery pack may include the battery module according to the embodiment. The battery pack may include a single battery in place of the battery module according to the embodiment.

The battery pack may further include a protective circuit. The protective circuit functions to control charge and discharge of the secondary battery. Alternatively, a circuit included in devices (such as electronic devices or automobiles) that use a battery pack as a power source may be used as the protective circuit of the battery pack.

The battery pack may further include an external power distribution terminal. The external power distribution terminal is configured to output current from the secondary battery to the outside and/or to input current to the secondary battery from the outside. In other words, when the battery pack is used as a power source, current is supplied to the outside via the external power distribution terminal. When the battery pack is to be charged, charging current (including a regenerative energy of a motive force of automobiles and the like) is supplied to the battery pack via the external power distribution terminal.

Next, an example of the battery pack according to the embodiment will be described with reference to the drawings.

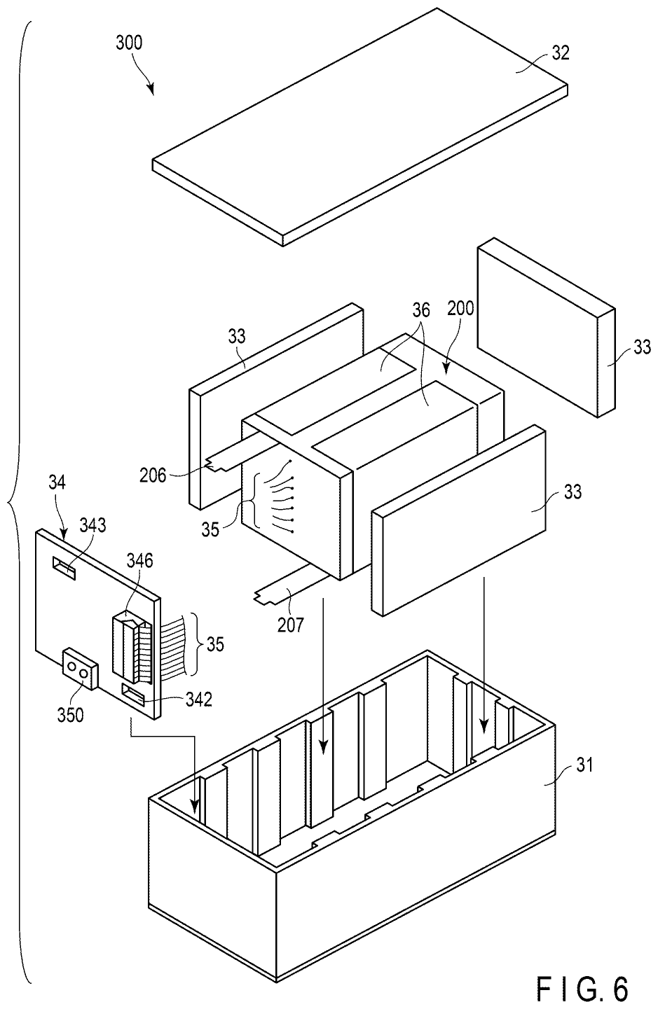

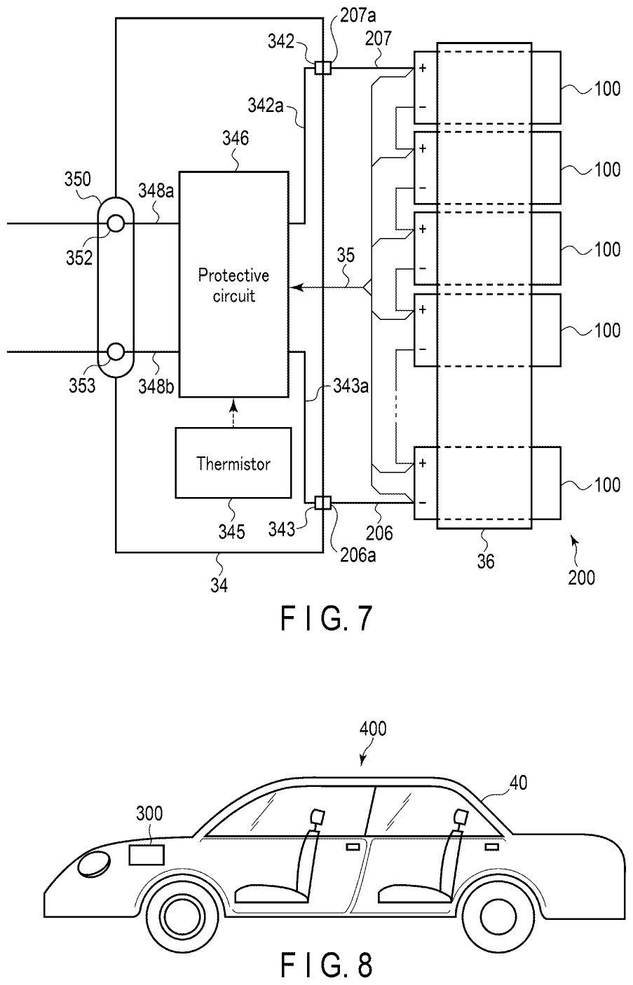

A battery pack 300 shown in FIGS. 6 and 7 includes a housing container 31, a lid 32, protective sheets 33, a battery module 200, a printed wiring board 34, wires 35, and an insulating plate (not shown).

The housing container 31 shown in FIG. 6 is a bottomed square-shaped container having a rectangular bottom surface. The housing container 31 is configured to house the protective sheets 33, the battery module 200, the printed wiring board 34, and the wires 35. The lid 32 has a rectangular shape. The lid 32 covers the housing container 31 to house the battery module 200 and the like. Although not shown, for example, opening(s) or connection terminal(s) for connecting to external device(s) and the like are provided on the housing container 31 and lid 32.

The battery module 200 includes a plurality of single batteries 100, a positive electrode-side lead 207, a negative electrode-side lead 206, and adhesive tape(s) 36.

At least one of the single batteries 100 is the secondary battery according to the embodiment. The single batteries 100 are electrically connected to each other in series, as shown in FIG. 7. Alternatively, the single batteries 100 may be electrically connected in parallel or in a combination of in-series connection and in-parallel connection. When the single batteries 100 are connected in parallel, the battery capacity increases as compared to the case where the single batteries are connected in series.

The adhesive tape(s) 36 fasten(s) the single batteries 100. The single batteries 100 may be fixed using a heat-shrinkable tape in place of the adhesive tape(s) 36. In this case, the protective sheets 33 are arranged on both side surfaces of the battery module 200, and the heat-shrinkable tape is wound around the battery module 200 and the protective sheets 33. After that, the heat-shrinkable tape is shrunk by heating to bundle the single batteries 100.

One end of the positive electrode-side lead 207 is connected to the battery module 200. One end of the positive electrode-side lead 207 is electrically connected to the positive electrode of one or more single batteries 100. One end of the negative electrode-side lead 206 is connected to the battery module 200. One end of the negative electrode-side lead 206 is electrically connected to the negative electrode of one or more single batteries 100.

The printed wiring board 34 is arranged on the inner surface of the housing container 31 along the short side direction. The printed wiring board 34 includes a positive electrode-side connector 342, a negative electrode-side connector 343, a thermistor 345, a protective circuit 346, wires 342a and 343a, an external power distribution terminal 350, a plus-side wire (positive-side wire) 348a, and a minus-side wire (negative-side wire) 348b. One of the main surfaces of the printed wiring board 34 faces a side surface of the battery module 200. An insulating plate (not shown) is interposed between the printed wiring board 34 and the battery module 200.

The other end 207a of the positive electrode-side lead 207 is electrically connected to the positive electrode-side connector 342. The other end 206a of the negative electrode-side lead 206 is electrically connected to the negative electrode-side connector 343.

The thermistor 345 is fixed to one of the main surfaces of the printed wiring board 34. The thermistor 345 detects the temperature of each of the single batteries 100, and the detection signals are transmitted to the protective circuit 346.

The external power distribution terminal 350 is fixed to the other of the main surfaces of the printed wiring board 34. The external power distribution terminal 350 is electrically connected to a device(s) outside the battery pack 300. The external power distribution terminal 350 includes a positive-side terminal 352 and a negative-side terminal 353.

The protective circuit 346 is fixed to the other of the main surfaces of the printed wiring board 34. The protective circuit 346 is connected to the positive-side terminal 352 via the plus-side wire 348a. The protective circuit 346 is connected to the negative-side terminal 353 via the minus-side wire 348b. The protective circuit 346 is also electrically connected to the positive electrode-side connector 342 via the wire 342a. The protective circuit 346 is electrically connected to the negative electrode-side connector 343 via the wire 343a. Further, the protective circuit 346 is electrically connected to each of the single batteries 100 via the wire 35.

The protective sheets 33 are arranged on both inner surfaces of the housing container 31 along the long side direction and on one inner surface of the housing container 31 along the short side direction facing the printed wiring board 34 through the battery module 200. The protective sheets 33 are made of, for example, resin or rubber.

The protective circuit 346 controls charge and discharge of the single batteries 100. The protective circuit 346 is also configured to cut off electric connection between the protective circuit 346 and the external power distribution terminal 350 (the positive-side terminal 352 and the negative-side terminal 353), based on detection signals transmitted from the thermistor 345 or detection signals transmitted from each single battery 100 or the battery module 200.

An example of the detection signal transmitted from the thermistor 345 is a signal indicating that the temperatures of the single batteries 100 are detected to be a predetermined temperature or higher. An example of the detection signal transmitted from the individual single batteries 100 or the battery module 200 is a signal indicating detection of over-charge, over-discharge, and over-current of the single batteries 100. In the case of detecting over-charge, etc., of the individual single batteries 100, a battery voltage may be detected, or a positive electrode potential or a negative electrode potential may be detected. In the latter case, a lithium electrode used as a reference electrode is inserted into each single battery 100.

A circuit included in devices (such as electronic devices or automobiles) that use the battery pack 300 as a power source may be used as the protective circuit 346.

The battery pack 300 also includes the external power distribution terminal 350, as described above. Thus, the battery pack 300 can output current from the battery module 200 to an external device and input current from an external device to the battery module 200 via the external power distribution terminal 350. In other words, when using the battery pack 300 as a power source, current from the battery module 200 is supplied to an external device via the external power distribution terminal 350. When charging the battery pack 300, charging current from an external device is supplied to the battery pack 300 via the external power distribution terminal 350. If the battery pack 300 is used as an in-vehicle battery, a regenerative energy of a motive force of the vehicle can be used as the charging current from the external device.

The battery pack 300 may include a plurality of battery modules 200. In this case, the plurality of battery modules 200 may be connected in series, in parallel, or in a combination of in-series connection and in-parallel connection. The printed wiring board 34 and the wire 35 may be omitted. In this case, the positive electrode-side lead 207 and the negative electrode-side lead 206 may be used as the positive-side terminal and the negative-side terminal of the external power distribution terminal, respectively.

Such a battery pack is used, for example, in applications where excellent cycle performance is demanded when a large current is extracted. Specifically, the battery pack is used as a power source of electronic devices, a stationary battery, and an in-vehicle battery for various vehicles. An example of the electronic devices is a digital camera. The battery pack is particularly suitably used as an in-vehicle battery.

The battery pack according to the third embodiment includes the secondary battery according to the embodiment or the battery module according to the embodiment. Therefore, the battery pack has excellent life performance.

### Fourth Embodiment

According to a fourth embodiment, a vehicle that includes the battery pack according to the embodiment is provided.

In the vehicle according to the embodiment, the battery pack is configured, for example, to recover a regenerative energy from a motive force of the vehicle. The vehicle may include a mechanism (regenerator) for converting a kinetic energy of the vehicle into a regenerative energy.

Examples of the vehicle according to the embodiment include two- or four-wheeled hybrid electric automobiles, two- or four-wheeled electric automobiles, power-assisted bicycles, and railway vehicles.

In the vehicle according to the embodiment, the installing position of the battery pack is not particularly limited. For example, when installing the battery pack in an automobile, the battery pack can be installed in the engine compartment of the vehicle, in a rear part of the vehicle or under a seat.

The vehicle according to the embodiment may include a plurality of battery packs. In this case, the batteries included in the respective battery packs may be electrically connected in series, in parallel, or in a combination of in-series connection and in-parallel connection. If the respective battery packs include a battery module, for example, the battery modules may be electrically connected in series, in parallel, or in a combination of in-series connection and in-parallel connection. Alternatively, if the respective battery packs include a single battery, the batteries may be electrically connected in series, in parallel, or in a combination of in-series connection and in-parallel connection.

Next, an example of the vehicle according to the embodiment will be described with reference to the drawings.

A vehicle 400 shown in FIG. 8 includes a vehicle body 40 and the battery pack 300 according to the embodiment. In the example shown in FIG. 8, the vehicle 400 is a four-wheeled automobile.

The vehicle 400 may include a plurality of battery packs 300. In this case, the batteries (e.g., single batteries or battery modules) included in the battery packs 300 may be connected in series, in parallel, or in a combination of in-series connection and in-parallel connection.

FIG. 8 shows an example in which the battery pack 300 is installed in the engine compartment in front of the vehicle body 40. The battery pack 300 may be installed, for example, in a rear part of the vehicle body 40, or under a seat. The battery pack 300 may be used as a power source of the vehicle 400. The battery pack 300 can also recover a regenerative energy of a motive force of the vehicle 400.

The vehicle according to the fourth embodiment includes the battery pack according to the embodiment. Therefore, the vehicle can exhibit high performance and has high reliability.

### Fifth Embodiment

According to a fifth embodiment, a stationary power supply that includes the battery pack according to the embodiment is provided.

The stationary power supply according to the embodiment may include the battery module according to the embodiment or the battery according to the embodiment, instead of the battery pack according to the embodiment. The stationary power supply according to the embodiment can exhibit a long life.

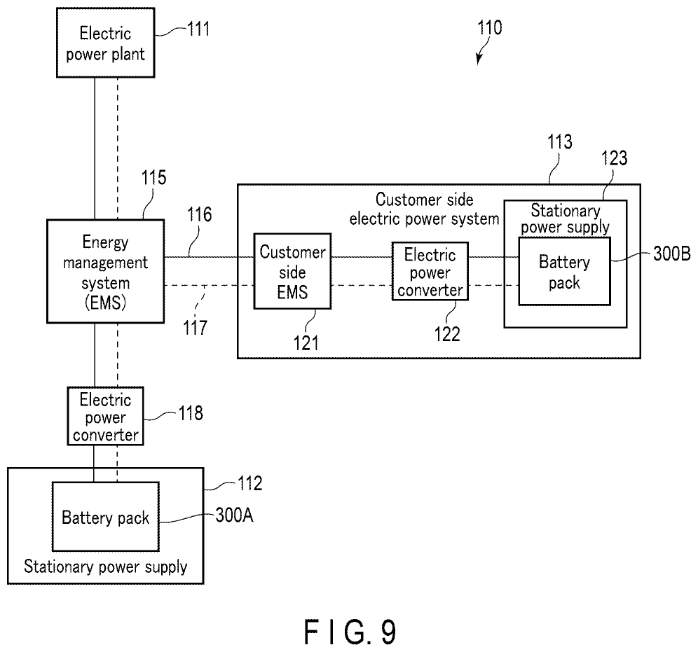

FIG. 9 shows an example of application to stationary power supplies 112 and 123 as an example of use of the battery packs 300A and 300B according to the embodiment. An example shown in FIG. 9 presents a system 110 which includes the stationary power supplies 112 and 123. The system 110 includes an electric power plant 111, the stationary power supply 112, a customer side electric power system 113, and an energy management system (EMS) 115. An electric power network 116 and a communication network 117 are formed in the system 110, and the electric power plant 111, the stationary power supply 112, the customer side electric power system 113 and the EMS 115 are connected via the electric power network 116 and the communication network 117. The EMS 115 utilizes the electric power network 116 and the communication network 117 to perform control to stabilize the entire system 110.

The electric power plant 111 generates a large amount of electric power from fuel sources such as thermal power and nuclear power. Electric power is supplied from the electric power plant 111 through the electric power network 116 and the like. The battery pack 300A is installed in the stationary power supply 112. The battery pack 300A can store electric power and the like supplied from the electric power plant 111. The stationary power supply 112 can also supply the electric power stored in the battery pack 300A through the electric power network 116 and the like. The system 110 is provided with an electric power converter 118. The electric power converter 118 includes a converter, an inverter, a transformer and the like. Thus, the electric power converter 118 can perform conversion between direct current and alternate current, conversion between alternate currents of different frequencies, voltage transformation (step-up and step-down), and the like. Accordingly, the electric power converter 118 can convert electric power from the electric power plant 111 into electric power that can be stored in the battery pack 300A.

The customer side electric power system 113 includes an electric power system for factories, an electric power system for buildings, an electric power system for home use, and the like. The customer side electric power system 113 includes a customer side EMS 121, an electric power converter 122, and the stationary power supply 123. The battery pack 300B is installed in the stationary power supply 123. The customer side EMS 121 performs control to stabilize the customer side electric power system 113.

Electric power from the electric power plant 111 and electric power from the battery pack 300A are supplied to the customer side electric power system 113 through the electric power network 116. The battery pack 300B can store electric power supplied to the customer side electric power system 113. Similarly to the electric power converter 118, the electric power converter 122 includes a converter, an inverter, a transformer and the like. Thus, the electric power converter 122 can perform conversion between direct current and alternate current, conversion between alternate currents of different frequencies, voltage transformation (step-up and step-down), and the like. Accordingly, the electric power converter 122 can convert electric power supplied to the customer side electric power system 113 into electric power that can be stored in the battery pack 300B.

The electric power stored in the battery pack 300B can be used, for example, for charging a vehicle such as an electric automobile. The system 110 may also be provided with a natural energy source. In this case, the natural energy source generates electric power from natural energy such as wind power and solar light. In addition to the electric power plant 111, electric power is also supplied from the natural energy source through the electric power network 116.

### EXAMPLES

Examples will be described below to explain the above embodiments in more detail; however, the inventions are not limited to these examples as long as the inventions do not deviate from the gist of the inventions.

### Example 1

### <Production of Negative Electrode>

Particles of a monoclinic niobium titanium-containing oxide having a composition represented by the formula Nb₂TiO₇ were provided as a negative electrode active material. The monoclinic niobium titanium-containing oxide has a composition represented by LiₐNb₂TiO₇ (0≤a≤5) in a battery. In addition, acetylene black was provided as a conductive agent, and carboxymethyl cellulose (CMC) and styrene-butadiene rubber (SBR) were provided as a binder. They were mixed in pure water at a weight ratio (% by mass) of negative electrode active material:acetylene black:carboxymethyl cellulose:styrene-butadiene rubber of 95:4.2:0.4:0.4, to obtain a slurry. This slurry was applied onto a current collector made of an aluminum foil having a thickness of 15 μm, and the coating was dried. In this manner, a composite including a current collector and a negative electrode active material-containing layer formed on the current collector was obtained. Next, the composite thus obtained was pressed. Then, the composite was further dried, whereby a negative electrode was obtained.

### <Production of Positive Electrode>

Particles of a lithium nickel cobalt manganese composite oxide represented by the formula LiNi_{0.33}Mn_{0.33}Co_{0.33}O₂ (referred to as “NMC111”) were provided as a positive electrode active material. In addition, acetylene black was provided as a conductive agent, and polyvinylidene fluoride (PVdF) was provided as a binder. They were mixed at a mass ratio (% by mass) of positive electrode active material:conductive agent:binder of 90:5:5, to obtain a mixture. Next, the obtained mixture was dispersed in an n-methylpyrrolidone (NMP) solvent to prepare a positive electrode slurry. This slurry was applied onto a current collector made of an aluminum foil having a thickness of 15 μm, and the coating was dried. In this manner, a composite including a current collector and a positive electrode active material-containing layer formed on both sides of the current collector was obtained. Next, the composite thus obtained was pressed. Then, the composite was further dried, whereby a positive electrode was obtained.

The positive electrode and the negative electrode were respectively cut out so that the area of the active material-containing layer was a width of 3 cm and the height was 5 cm. A single negative electrode and a single positive electrode were stacked with a cellulose separator having a thickness of 30 μm interposed therebetween, to prepare an electrode stack as an electrode group. Also, in order to collect current, an aluminum tab having a thickness of 0.2 mm was attached to the negative electrode and the positive electrode. The electrode stack prepared was housed in a container member made of a laminated film, a liquid electrolyte was injected thereinto, and then the container member was sealed, whereby a secondary battery was obtained.

The liquid electrolyte had a composition consisting of 48.5% by mass of LiN(CF₃SO₂)₂ (LiTFSI), 50.4% by mass of ethylene carbonate (EC), 1.0% by mass of lithium nitrate (LiNO₃), and 0.1% by mass of H₂O. The lithium salt concentration of the liquid electrolyte was 3.3 mol/kg.

After the injection of the electrolytic solution, the battery was maintained in a thermostatic bath at 60° C. for 30 minutes to perform aging, then charged to a SOC of 100% at a current rate of 0.05 C at 25° C., and then discharged to a SOC of 0% at a current rate of 0.1 C. Thereafter, the battery was unsealed to remove generated gas, and sealed again under reduced pressure, and a charge-and-discharge cycle test was conducted at 25° C. At 25° C., the battery is charged up to 2.9 V at 0.2 C, and then discharged down to 1.8 V at 0.2 C. This charge-and-discharge cycle was repeated 50 times, and the retention rate (%) of the discharge capacity in the 50th cycle relative to the discharge capacity in the 1st cycle was calculated. The retention ratio thus calculated is shown in Table 2 as a capacity retention ratio during the charge-and-discharge cycle.

### Example 2

A secondary battery was produced in the same manner as described in Example 1 except that TiO₂(B) was used as a negative electrode active material, and a charge-and-discharge cycle test was conducted.

### Example 3

A negative electrode was produced in the same manner as described in Example 1 except that Li₄Ti₅O₁₂ having a spinel structure was used as a negative electrode active material, acetylene black was used as a conductive agent, polyvinylidene fluoride (PVdF) was used as a binder, and they were mixed at a mass ratio (% by mass) of negative electrode active material:conductive agent:binder was 90:5:5. A secondary battery was produced in the same manner as described in Example 1 except that the obtained negative electrode was used, and a charge-and-discharge cycle test was conducted.

### Example 4

A secondary battery was produced in the same manner as described in Example 1 except that Nb₁₀Ti₂O₂₉ was used as a negative electrode active material, and a charge-and-discharge cycle test was conducted.

### Example 5

A positive electrode was produced in the same manner as described in Example 1 except that LiAl_{0.2}Mn_{1.8}O₄ (LMO) was used as a positive electrode active material. In addition, the liquid electrolyte used had a composition consisting of 36.4% by mass of LiN(CF₃SO₂)₂ (LiTFSI), 2.4% by mass of LiN(F₂SO₂)₂(LiFSI), 60.1% by mass of trimethyl phosphate (TMP), 1.0% by mass of lithium nitrate and 0.1% by mass of H₂O. The lithium salt concentration of the liquid electrolyte was 2.3 mol/kg. The lithium salt concentration described in Table 1 is a value obtained by adding up the LiTFSI concentration and the LiFSI concentration. A secondary battery was produced in the same manner as described in Example 1 except that the obtained positive electrode and liquid electrolyte were used, and a charge-and-discharge cycle test was conducted.

### Example 6

A positive electrode was produced in the same manner as described in Example 1 except that LiMn_{0.7}Fe_{0.3}PO₄ (LMFP) was used as a positive electrode active material. In addition, the liquid electrolyte used had a composition consisting of 36.3% by mass of LiN(CF₃SO₂)₂ (LiTFSI), 2.5% by mass of LiB(C₂O₄)₂ (LiBOB), 60.1% by mass of trimethyl phosphate (TMP), 1.0% by mass of lithium nitrate and 0.1% by mass of H₂O. The lithium salt concentration of the liquid electrolyte was 2.3 mol/kg. The lithium salt concentration described in Table 1 is a value obtained by adding up the LiTFSI concentration and the LiBOB concentration. A secondary battery was produced in the same manner as described in Example 1 except that the obtained positive electrode and liquid electrolyte were used, and a charge-and-discharge cycle test was conducted.

### Example 7

A positive electrode was produced in the same manner as described in Example 1 except that LiNi_{0.5}Mn_{1.5}O₄ (LNMO) was used as a positive electrode active material. In addition, the liquid electrolyte used had a composition consisting of 37.3% by mass of LiN(CF₃SO₂)₂ (LiTFSI), 61.6% by mass of trimethyl phosphate (TMP), 1.0% by mass of lithium nitrate and 0.1% by mass of H₂O. The lithium salt concentration of the liquid electrolyte was 2.0 mol/kg. A secondary battery was produced in the same manner as described in Example 1 except that the obtained positive electrode and liquid electrolyte were used, and a charge-and-discharge cycle test was conducted.

### Example 8

The liquid electrolyte used had a composition consisting of 37.5% by mass of LiN(CF₃SO₂)₂ (LiTFSI), 61.9% by mass of trimethyl phosphate (TMP), 0.5% by mass of sodium nitrate and 0.1% by mass of H₂O. The lithium salt concentration of the liquid electrolyte was 2.0 mol/kg. A secondary battery was produced in the same manner as described in Example 1 except that the obtained liquid electrolyte was used, and a charge-and-discharge cycle test was conducted.

### Example 9

In addition, the liquid electrolyte used had a composition consisting of 37.5% by mass of LiN(CF₃SO₂)₂ (LiTFSI), 61.9% by mass of trimethyl phosphate (TMP), 0.5% by mass of lithium nitrite and 0.1% by mass of H₂O. The lithium salt concentration of the liquid electrolyte was 2.0 mol/kg. A secondary battery was produced in the same manner as described in Example 1 except that the obtained liquid electrolyte was used, and a charge-and-discharge cycle test was conducted.

### Example 10

The liquid electrolyte used had a composition consisting of 37.5% by mass of LiN(CF₃SO₂)₂ (LiTFSI), 61.9% by mass of trimethyl phosphate (TMP), 0.5% by mass of sodium nitrite and 0.1% by mass of H₂O. The lithium salt concentration of the liquid electrolyte was 2.0 mol/kg. A secondary battery was produced in the same manner as described in Example 1 except that the obtained liquid electrolyte was used, and a charge-and-discharge cycle test was conducted.

### Example 11

The liquid electrolyte used had a composition consisting of 37.3% by mass of LiN(CF₃SO₂)₂ (LiTFSI), 61.684% by mass of trimethyl phosphate (TMP), 1.0% by mass of lithium nitrite and 0.016% by mass of H₂O. The lithium salt concentration of the liquid electrolyte was 2.0 mol/kg. A secondary battery was produced in the same manner as described in Example 1 except that the obtained liquid electrolyte was used, and a charge-and-discharge cycle test was conducted.

### Example 12

The liquid electrolyte used had a composition consisting of 37.1% by mass of LiN(CF₃SO₂)₂ (LiTFSI), 61.35% by mass of trimethyl phosphate (TMP), 1.0% by mass of lithium nitrite and 0.55% by mass of H₂O. The lithium salt concentration of the liquid electrolyte was 2.0 mol/kg. A secondary battery was produced in the same manner as described in Example 1 except that the obtained liquid electrolyte was used, and a charge-and-discharge cycle test was conducted.

### Example 13

The liquid electrolyte used had a composition consisting of 37.1% by mass of LiN(CF₃SO₂)₂ (LiTFSI), 52.4% by mass of trimethyl phosphate (TMP), 1.0% by mass of lithium nitrite and 9.5% by mass of H₂O. The lithium salt concentration of the liquid electrolyte was 2.0 mol/kg. A secondary battery was produced in the same manner as described in Example 1 except that the obtained liquid electrolyte was used, and a charge-and-discharge cycle test was conducted.

### Example 14

A positive electrode was produced in the same manner as described in Example 1 except that an aluminum foil subjected to plasma nitriding treatment was used as a positive electrode current collector. A secondary battery was produced in the same manner as described in Example 1 except that the obtained positive electrode was used, and a charge-and-discharge cycle test was conducted.

### Example 15

The liquid electrolyte used had a composition consisting of 48.5% by mass of LiN(CF₃SO₂)₂(LiTFSI), 50.4% by mass of ethylene carbonate (EC), 1.0% by mass of adiponitrile, and 0.1% by mass of H₂O. The lithium salt concentration of the liquid electrolyte was 3.3 mol/kg. A secondary battery was produced in the same manner as described in Example 1 except that the obtained liquid electrolyte was used, and a charge-and-discharge cycle test was conducted.

### Comparative Example 1

The liquid electrolyte used had a composition consisting of 49.0% by mass of LiN(CF₃SO₂)₂ (LiTFSI), 50.9% by mass of ethylene carbonate (EC), and 0.1% by mass of H₂O. The lithium salt concentration of the liquid electrolyte was 3.3 mol/kg. A secondary battery was produced in the same manner as described in Example 1 except that the obtained liquid electrolyte was used, and a charge-and-discharge cycle test was conducted.

Table 1 shows the composition of the negative electrode active material, the composition of the positive electrode active material, the type of the N-containing compound, the concentration (% by mass) of the N-containing compound in the electrolyte, the concentration of water (content of water) (ppm by mass) in the electrolyte, the type of the lithium salt contained in the electrolyte and the type of the solvent other than water, and the concentration (mol/kg) of the lithium salt in the electrolyte for examples and comparative examples.

The surface states of the positive electrode current collector and the positive electrode active material-containing layer of the secondary battery of each of Examples 1 to 15 were examined by the XPS analysis. For Examples 1 to 13, it was possible to confirm that Li₃N and AlN were present at each of a surface of the positive electrode active material-containing layer and a surface of the positive electrode current collector which is in contact with the positive electrode active material-containing layer. For example, there are a N1S peak at around 397 eV, a Li1S peak at around 56 eV, and an Al2P peak at around 73 eV. They may be derived from compounds such as Li—N or Al—N, which can be rephrased as “Li₃N and AlN are present”.

For Example 14, it was possible to confirm that an oxide in which a part of oxide is nitrided was present at a surface of the positive electrode current collector which is in contact with the positive electrode active material-containing layer. It is presumed that the oxide in which a part of oxygen is nitrided was formed by nitriding an Al passive film on the surface of the positive electrode current collector. In addition, for Example 15, it was possible to confirm that an organic compound having a CN bond was present at a surface of the positive electrode active material-containing layer and a surface of the positive electrode current collector which is in contact with the positive electrode active material-containing layer.

On the other hand, the surface states of the positive electrode current collector and the positive electrode active material-containing layer of the secondary battery of Comparative Example 1 were examined by the XPS analysis, and the result showed that a nitrogen-containing substance was not present.

TABLE 1

| | Negative | Positive | | | | | |
|---|---|---|---|---|---|---|---|
| | electrode | electrode | | N-containing | | | Concentration |
| | active | active | Electrolyte | compound | Concentration | | of lithium |
| | material | material | N-containing | Concentration | of water | | salt |
| | Composition | Composition | compound | (% by mass) | (ppm by mass) | Lithium salt and solvent | (mol/kg) |
| Example 1 | Nb₂TiO₇ | NMC111 | Lithium nitrate | 1 | 1000 | LiTFSI + EC | 3.3 |
| Example 2 | TiO₂ (B) | NMC111 | Lithium nitrate | 1 | 1000 | LiTFSI + EC | 3.3 |
| Example 3 | Li₄Ti₅O₁₂ | NMC111 | Lithium nitrate | 1 | 1000 | LiTFSI + EC | 3.3 |
| Example 4 | Nb₁₀Ti₂O₂₉ | NMC111 | Lithium nitrate | 1 | 1000 | LiTFSI + EC | 3.3 |
| Example 5 | Nb₂TiO₇ | LMO | Lithium nitrate | 1 | 1000 | LiTFSI + LiFSI + TMP | 2.3 |
| Example 6 | Nb₂TiO₇ | LMFP | Lithium nitrate | 1 | 1000 | LiTFSI + LiBoB + TMP | 2.3 |
| Example 7 | Nb₂TiO₇ | LNMO | Lithium nitrate | 1 | 1000 | LiTFSI + TMP | 2.0 |
| Example 8 | Nb₂TiO₇ | NMC111 | Sodium nitrate | 0.5 | 1000 | LiTFSI + TMP | 2.0 |
| Example 9 | Nb₂TiO₇ | NMC111 | Lithium nitrate | 0.5 | 1000 | LiTFSI + TMP | 2.0 |
| Example 10 | Nb₂TiO₇ | NMC111 | Sodium nitrite | 0.5 | 1000 | LiTFSI + TMP | 2.0 |
| Example 11 | Nb₂TiO₇ | NMC111 | Lithium nitrate | 1 | 160 | LiTFSI + TMP | 2.0 |
| Example 12 | Nb₂TiO₇ | NMC111 | Lithium nitrate | 1 | 5500 | LiTFSI + TMP | 2.0 |
| Example 13 | Nb₂TiO₇ | NMC111 | Lithium nitrate | 1 | 95000 | LiTFSI + TMP | 2.0 |
| Example 14 | Nb₂TiO₇ | NMC111 | Not added | — | 1000 | LiTFSI + EC | 3.3 |
| Example 15 | Nb₂TiO₇ | NMC111 | Adiponitrile | 1 | 1000 | LiTFSI + EC | 3.3 |
| Comparative | Nb₂TiO₇ | NMC111 | Not added | — | 1000 | LiTFSI + EC | 3.3 |
| Example 1 | | | | | | | |

TABLE 2

| | Capacity retention |
|---|---|
| | ratio during cycle |
| | (%) |
| Example 1 | 93 |
| Example 2 | 92 |
| Example 3 | 97 |
| Example 4 | 93 |
| Example 5 | 92 |
| Example 6 | 90 |
| Example 7 | 87 |
| Example 8 | 91 |
| Example 9 | 93 |
| Example 10 | 92 |
| Example 11 | 95 |
| Example 12 | 90 |
| Example 13 | 86 |
| Example 14 | 79 |
| Example 15 | 80 |
| Comparative | 76 |
| Example 1 | |

As is apparent from Tables 1 to 2, the secondary batteries of Examples 1 to 15 have a higher capacity retention ratio during the charge-and-discharge cycle than the secondary battery of Comparative Example 1. The positive electrode current collector was more corroded in the secondary battery of Comparative Example 1 than in the secondary batteries of Examples 1 to 15.

The secondary batteries of Examples 1 to 13 in which the nitrogen-containing substance contains a metal nitride had a higher capacity retention ratio during the charge-and-discharge cycle than the secondary battery of Example 14 with a nitrogen-containing substance containing an oxide in which a part of oxygen is nitrided and the secondary battery of Example 15 with a nitrogen-containing substance containing an organic compound having a CN bond.

The inventions of the embodiments are appended below.

<1>. A secondary battery including:
an electrolyte including water and a lithium salt;
a positive electrode including a positive electrode active material-containing layer, a positive electrode current collector supporting the positive electrode active material-containing layer and including at least one of aluminum or an aluminum alloy, and a nitrogen-containing substance present at at least a part of a surface of the positive electrode current collector; and
a negative electrode.

<2>. The secondary battery according to <1>, wherein the positive electrode further includes a nitrogen-containing substance present at at least a part of a surface of the positive electrode active material-containing layer.

<3>. The secondary battery according to <1> or <2>, wherein the electrolyte includes at least one selected from the group consisting of lithium nitrate, sodium nitrate, potassium nitrate, magnesium nitrate, calcium nitrate, lithium nitrite, sodium nitrite, potassium nitrite, magnesium nitrite and calcium nitrite.

<4>. The secondary battery according to any one of <1> to <3>, wherein a content of water in the electrolyte is 150 ppm to 100,000 ppm.

<5>. The secondary battery according to any one of <1> to <4>, wherein a positive electrode active material contained in the positive electrode active material-containing layer includes at least one selected from the group consisting of a lithium nickel cobalt manganese composite oxide, a lithium nickel manganese composite oxide, a lithium cobalt composite oxide and a lithium manganese iron composite oxide.

<6>. The secondary battery according to any one of <1> to <5>, wherein the negative electrode includes at least one selected from the group consisting of a niobium titanium-containing oxide, a titanium oxide, a lithium titanium-containing oxide and carbon.

<7>. The secondary battery according to any one of <1> to <6>, wherein the negative electrode includes at least one selected from the group consisting of a monoclinic niobium titanium-containing oxide, TiO₂ (B) and Li₄₊ₓTi₅O₁₂ (−1≤x≤3).

<8>. A battery pack including the secondary battery according to any one of <1> to <7>.

<9>. The battery pack according to <8>, further including an external power distribution terminal and a protective circuit.

<10>. The battery pack according to <8> or <9>, including a plurality of the secondary battery, wherein the secondary batteries are electrically connected in series, in parallel, or in combination of series and parallel.

<11>. A vehicle including the battery pack according to any one of <8> to <10>.

<12>. The vehicle according to <11>, including a mechanism configured to convert kinetic energy of the vehicle into regenerative energy.

<13>. A stationary power supply including the battery pack according to any one of <8> to <10>.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A secondary battery comprising:
an electrolyte comprising water and a lithium salt;
a positive electrode comprising a positive electrode active material-containing layer, a positive electrode current collector supporting the positive electrode active material-containing layer and comprising at least one of aluminum or an aluminum alloy, and a nitrogen-containing substance present at least a part of a surface of the positive electrode current collector; and
a negative electrode.

2. The secondary battery according to claim 1, wherein the positive electrode further comprises a nitrogen-containing substance present at least a part of a surface of the positive electrode active material-containing layer.

3. The secondary battery according to claim 1, wherein the electrolyte comprises at least one selected from the group consisting of lithium nitrate, sodium nitrate, potassium nitrate, magnesium nitrate, calcium nitrate, lithium nitrite, sodium nitrite, potassium nitrite, magnesium nitrite and calcium nitrite.

4. The secondary battery according to claim 1, wherein a content of water in the electrolyte is 150 ppm to 100,000 ppm.

5. The secondary battery according to claim 1, wherein a positive electrode active material contained in the positive electrode active material-containing layer comprises at least one selected from the group consisting of a lithium nickel cobalt manganese composite oxide, a lithium nickel manganese composite oxide, a lithium cobalt composite oxide and a lithium manganese iron composite oxide.

6. The secondary battery according to claim 1, wherein the negative electrode comprises at least one selected from the group consisting of a niobium titanium-containing oxide, a titanium oxide, a lithium titanium-containing oxide and carbon.

7. The secondary battery according to claim 1, wherein the negative electrode comprises at least one selected from the group consisting of a monoclinic niobium titanium-containing oxide, TiO₂ (B) and Li₄₊ₓTi₅O₁₂ (−1≤x≤3).

8. A battery pack comprising the secondary battery according to claim 1.

9. The battery pack according to claim 8, further comprising an external power distribution terminal and a protective circuit.

10. The battery pack according to claim 9, comprising a plurality of secondary batteries, wherein the secondary batteries are electrically connected in series, in parallel, or in combination of series and parallel.

11. A stationary power supply comprising the battery pack according to claim 8.
